(19) United States
(12) Patent Application Publication
(10) Pub. No.: US 2021/0019825 A1
(43) Pub. Date: Jan. 21, 2021

(54) Time-Based Watch List Management

(71) Applicant: INTERNATIONAL BUSINESS MACHINES CORPORATION, Armonk, NY (US)

(72) Inventors: Collin Preston, Rochester, NY (US); Rosendo Luis Martinez, Arlington, VA (US)

(21) Appl. No.: 16/517,455

(22) Filed: Jul. 19, 2019

(51) Int. Cl. G06Q 40/04; G06F 3/0482; G06F 16/215; G06F 16/26; G06F 16/957; H04W 4/20

(52) U.S. Cl. CPC G06Q 40/04; G06F 3/0482; H04W 4/20; G06F 16/26; G06F 16/957; G06F 16/215

(57) ABSTRACT

A method for providing a watch list to a user device includes receiving a specification of an item to be added to the watch list, receiving a specification of an amount of time beyond which to automatically remove the item from the watch list, and adding the item to the watch list. The method also includes automatically removing the item from the watch list based on a determination that an amount of time corresponding to how long the item has been on the watch list exceeds the amount of time beyond which to remove the item from the watch list. The method also includes, after automatically removing the item from the watch list, communicating the watch list, without the item, to the user device.

### BACKGROUND

In general, a watch list (or “watchlist”) comprises a list of items that someone is, for whatever reason, particularly interested in monitoring. Electronic watch lists have been used in various fields, including securities trading, law enforcement and national security, and media services.

### SUMMARY

A method for providing a watch list to a user device is disclosed. The method includes receiving a specification of an item to be added to the watch list, receiving a specification of an amount of time beyond which to automatically remove the item from the watch list, and adding the item to the watch list. The method also includes automatically removing the item from the watch list based on a determination that an amount of time corresponding to how long the item has been on the watch list exceeds the amount of time beyond which to remove the item from the watch list. The method also includes, after automatically removing the item from the watch list, communicating the watch list, without the item, to the user device.

A system for providing a watch list to a user device is disclosed. The system includes a memory having instructions therein and at least one processor in communication with the memory. The at least one processor is configured to execute the instructions to receive a specification of an item to be added to the watch list, receive a specification of an amount of time beyond which to automatically remove the item from the watch list, and add the item to the watch list. The at least one processor is also configured to execute the instructions to automatically remove the item from the watch list based on a determination that an amount of time corresponding to how long the item has been on the watch list exceeds the amount of time beyond which to remove the item from the watch list. The at least one processor is also configured to execute the instructions to, after the item has been automatically removed from the watch list, communicate the watch list, without the item, to the user device.

A computer program product for providing a watch list to a user device is also disclosed. The computer program product includes a computer readable storage medium having program instructions embodied therewith. The program instructions are executable by at least one processor to cause the at least one processor to receive a specification of an item to be added to the watch list, receive a specification of an amount of time beyond which to automatically remove the item from the watch list, and add the item to the watch list. The program instructions are also executable by the at the least one processor to cause the at least one processor to automatically remove the item from the watch list based on a determination that an amount of time corresponding to how long the item has been on the watch list exceeds the amount of time beyond which to remove the item from the watch list. The program instructions are also executable by the at the least one processor to cause the at least one processor to, after the item has been automatically removed from the watch list, communicate the watch list, without the item, to the user device.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram illustrating a network environment in accordance with aspects of the present disclosure.

FIG. 2 is a block diagram illustrating a watch list system in accordance with aspects of the present disclosure.

FIG. 3 is a flowchart illustrating a watch list method in accordance with aspects of the present disclosure.

FIG. 4 is a flowchart illustrating a time-based watch list modification method in accordance with aspects of the present disclosure.

FIG. 5 is a block diagram illustrating a hardware architecture of a data processing system in accordance with aspects of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

A “module” or “unit” as referenced herein comprises one or more hardware or electrical components such as electrical circuitry, processors, and memory that may be specially configured to perform a particular function. The memory may comprise volatile memory or non-volatile memory that stores data such as, but not limited to, computer executable instructions, machine code, and other various forms of data. The module or unit may be configured to use the data to execute one or more instructions to perform one or more tasks. In certain instances, a module or unit may also refer to a particular set of functions, software instructions, or circuitry that is configured to perform a specific task. For example, a module or unit may comprise software components such as, but not limited to, data access objects, service components, user interface components, application programming interface (“API”) components; hardware components such as electrical circuitry, processors, and memory; and/or a combination thereof As referenced herein, computer executable instructions may be in any form including, but not limited to, machine code, assembly code, and high-level programming code written in any programming language.

Also, as used herein, the term “communicate” and inflections thereof mean to receive and/or transmit data or information over a communication link. The communication link may include both wired and wireless links, and may comprise a direct link or may comprise multiple links passing through one or more communication networks or network devices such as, but not limited to, routers, firewalls, servers, and switches. The communication networks may comprise any type of wired or wireless network. The networks may include private networks and/or public networks such as the Internet. Additionally, in some embodiments, the term communicate may also encompass internal communication between various components of a system and/or with an external input/output device such as a keyboard or display device.

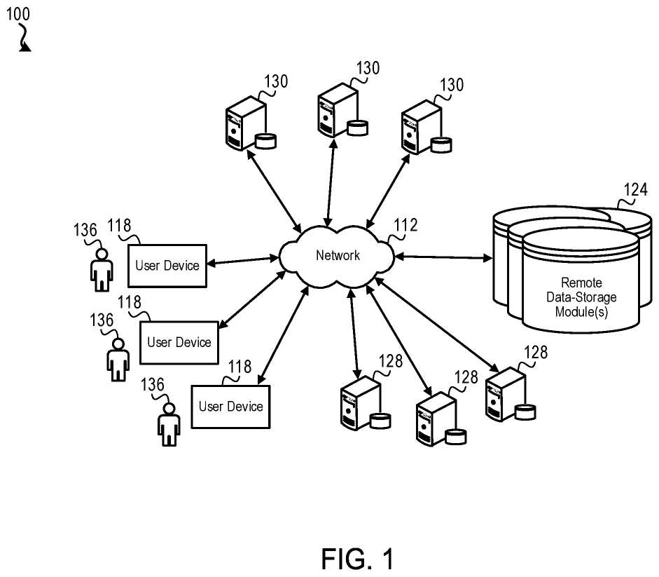

FIG. 1 is a block diagram illustrating a network environment 100 in accordance with aspects of the present disclosure. The network environment 100 includes a network 112, one or more user devices 118, one or more remote data-storage modules 124, one or more information services server devices 128, one or more watch list server devices 130, and one or more users 136.

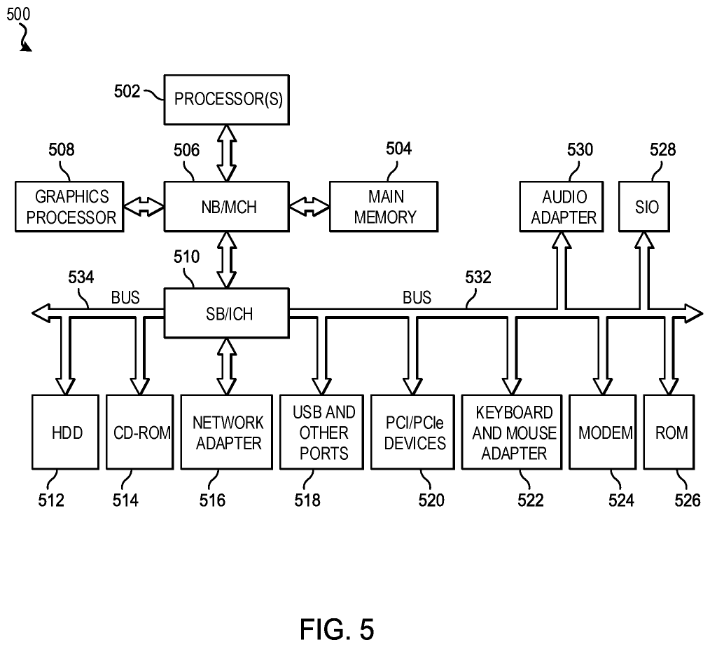

The network 112 comprises any type of network that enables the one or more user devices 118, the one or more remote data-storage modules 124, the one or more information services server devices 128, and the one or more watch list server devices 130 to communicate with each other through (i.e., “over”) the network 112. For example, the network 112 may comprise one or more wired and/or wireless networks such as, but not limited to, one or more radio networks (e.g., cellular network or mobile network), one or more local area networks (“LANs”), one or more wide area networks (“WANs”), one or more metropolitan area networks (“MANs”), etc. The network 112 may also comprise one or more private networks and/or one or more public networks (such as, but not limited to, the Internet). In some embodiments, the network 112 may comprise a corresponding one or more of the data processing system 500 (the data processing system 500 is not shown in FIG. 1, but see FIG. 5). In some embodiments, the network 112 may comprise one or more suitable computers, machines, modules, and/or devices provided by an Internet service provider.

Each of the one or more user devices 118 is communicatively coupled to the network 112 and is communicatively coupled (through the network 112) to each other, to the one or more remote data-storage modules 124, to the one or more information services server devices 128, and to the one or more watch list server devices 130. Each of the one or more user devices 118 comprises any type of device that allows the one or more users 136 to audibly, textually, or otherwise suitably interact with the one or more watch list server devices 130 through the network 112. Non-limiting examples of one of the one or more user devices 118 include a personal computer (desktop or laptop), a mobile device (e.g., personal digital assistant (“PDA”), smart phone, tablet, etc.), and a cognitive voice assistant device (e.g., Amazon's Alexa®, a Google Home® device, etc.). In some embodiments, the one or more user devices 118 may comprise a corresponding one or more of a data processing system 500 (the data processing system 500 is not shown in FIG. 1, but see FIG. 5).

Each of the one or more remote data-storage modules 124 is communicatively coupled to the network 112 and is communicatively coupled (through the network 112) to each other, to the one or more user devices 118, to the one or more information services server devices 128, and to the one or more watch list server devices 130. The one or more remote data-storage modules 124 are configured to (alone or in combination) store and provide access to various data that may be generated, modified, and/or used in accordance with aspects of the present disclosure. In some embodiments, the one or more remote data-storage modules 124 may comprise a corresponding one or more of a data processing system 500 (the data processing system 500 is not shown in FIG. 1, but see FIG. 5). In some embodiments, the one or more remote data-storage modules 124 may comprise one or more suitable computers, machines, modules, and/or devices provided by an Internet service provider.

Each of the one or more information services server devices 128 is communicatively coupled to the network 112 and is communicatively coupled (through the network 112) to each other, to the one or more user devices 118, to the one or more remote data-storage modules 124, and to the one or more watch list server devices 130. Each of the one or more information services server devices 128 comprises any type of device that can (alone or in combination with one or more other components of the network environment 100) suitably provide information (e.g., the price of a stock, the whereabouts of a person, or any other suitable information) for monitoring items on a watch list in accordance with aspects of the present disclosure. In some embodiments, the one or more information services server devices 128 may comprise a corresponding one or more of the data processing system 500 (the data processing system 500 is not shown in FIG. 1, but see FIG. 5). In some embodiments, the one or more information services server devices 128 may comprise one or more suitable computers, machines, modules, and/or devices provided by an Internet service provider, a securities exchange, a brokerage service, a law enforcement or national security agency, a media service, and/or any other suitable party or parties.

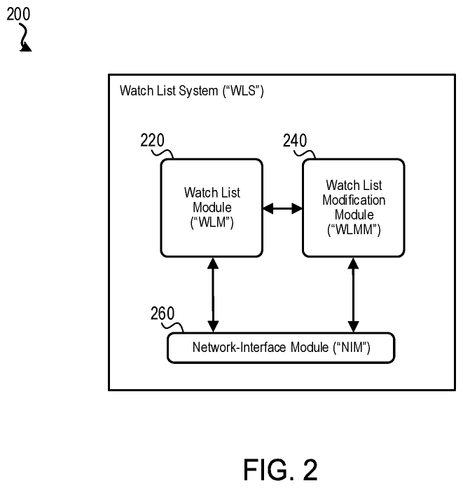

Each of the one or more watch list server devices 130 is communicatively coupled to the network 112 and is communicatively coupled (through the network 112) to each other, to the one or more user devices 118, to the one or more remote data-storage modules 124, and to the one or more information services server devices 128. Each of the one or more watch list server devices 130 comprises any type of device that can (alone or in combination with one or more other components of the network environment 100) suitably implement a watch list system 200 in accordance with aspects of the present disclosure (the watch list system 200 is not shown in FIG. 1, but see FIG. 2). In some embodiments, the one or more watch list server devices 130 may comprise a corresponding one or more of the data processing system 500 (the data processing system 500 is not shown in FIG. 1, but see FIG. 5). In some embodiments, the one or more watch list server devices 130 may comprise one or more suitable computers, machines, modules, and/or devices provided by an Internet service provider.

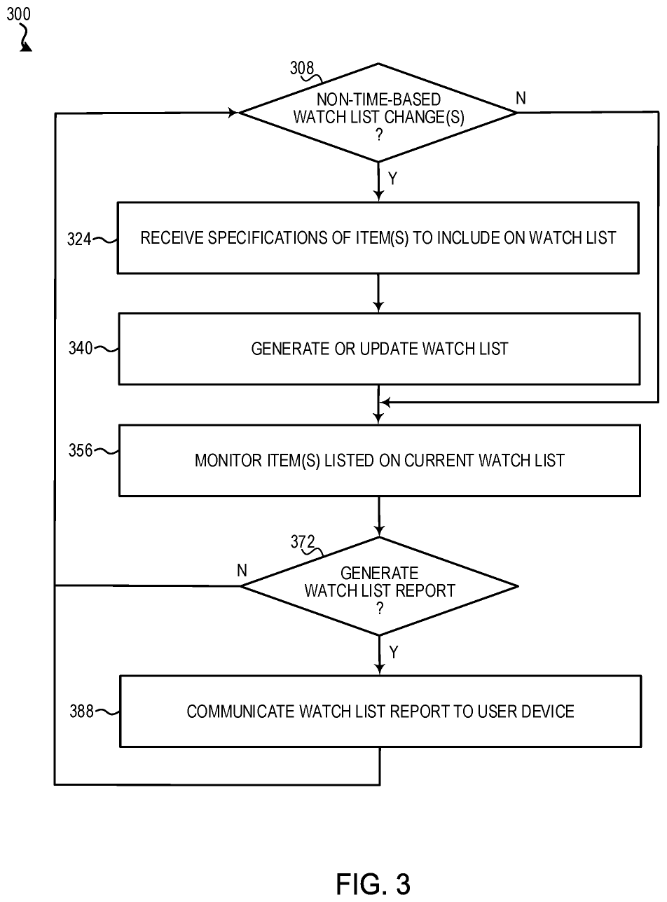

FIG. 2 is a block diagram illustrating the watch list system (“WLS”) 200 in accordance with aspects of the present disclosure. The WLS 200 includes a watch list module (“WLM”) 220. The WLM 220 is configured to suitably implement a watch list method 300 in accordance with aspects of the present disclosure (the method 300 is not shown in FIG. 2, but see FIG. 3). In some embodiments, the WLM 220 may be a component of one of the watch list server devices 130 (the watch list server devices 130 are not shown in FIG. 2, but see FIG. 1). In some embodiments, the WLM 220 may comprise one or more of the data processing system 500 (the data processing system 500 is not shown in FIG. 2, but see FIG. 5).

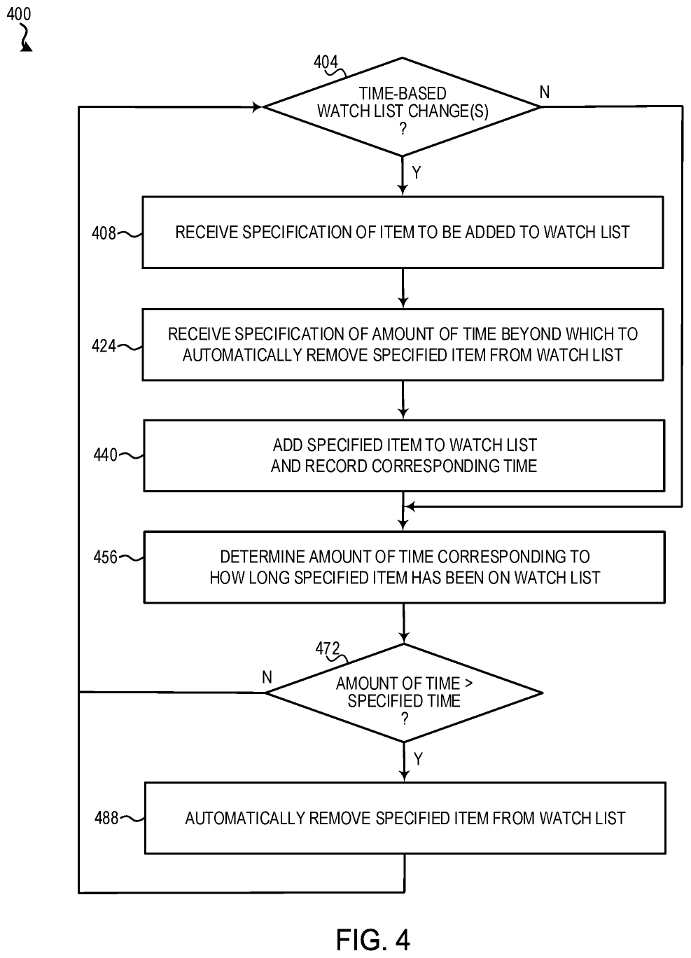

The WLS 200 also includes a watch list modification module (“WLMM”) 240. The WLMM 240 is configured to suitably implement a time-based watch list modification method 400 in accordance with aspects of the present disclosure (the method 400 is not shown in FIG. 2, but see FIG. 4). In some embodiments, the WLMM 240 may be a component of one of the watch list server devices 130 (the watch list server devices 130 are not shown in FIG. 2, but see FIG. 1). In some embodiments, the WLMM 240 may comprise one or more of the data processing system 500 (the data processing system 500 is not shown in FIG. 2, but see FIG. 5).

The WLS 200 also includes a network-interface module (“NIM”) 260. The NIM 260 is communicatively coupled to, among other things, the WLM 220, the WLMM 240, and the network 112 (the network 112 is not shown in FIG. 2, but see FIG. 1). It should be appreciated that the NIM 260 is also communicatively coupled (through the network 112) to the one or more user devices 118, to the one or more remote data-storage modules 124, to the one or more information services server devices 128, and to the one or more watch list server devices 130 (the user devices 118, the remote data-storage modules 124, the information services server devices 128, and the watch list server devices 130 are not shown in FIG. 2, but see FIG. 1). The NIM 260 is configured to communicatively couple and act as an interface between the WLS 200 and the network 112 (and to communicatively couple (through the network 112) the WLS 200 to various other components of the network environment 100) in accordance with aspects of the present disclosure. In some embodiments, the NIM 260 may be a component of one of the watch list server devices 130 (the watch list server devices 130 are not shown in FIG. 2, but see FIG. 1). In some embodiments, the NIM 260 may comprise one or more of the data processing system 500 (the data processing system 500 is not shown in FIG. 2, but see FIG. 5).

FIG. 3 is a flowchart illustrating the watch list method 300 in accordance with aspects of the present disclosure. In some instances, one or more steps of the method 300 may be performed by one or more of the systems and/or components described herein. For clarity of exposition, the following description may refer to one or more of such systems and/or components. Nevertheless, it should be appreciated that the method 300 and/or any one or more of its particular steps may be performed by any suitable system(s) and/or component(s). It should also be appreciated that the method 300 may be performed concurrently or substantially concurrently with any other method(s) and/or process(es) described herein.

At step 308, the method 300 determines whether the method 300 will make one or more non-time-based changes to a watch list (as opposed to one or more time-based changes, described below in connection with the method 400, which is illustrated in FIG. 4). Non-limiting examples of such non-time-based watch list changes are generating a new watch list, adding one or more items to a preexisting (i.e., previously generated) watch list that are to remain on the watch list for an indefinite amount of time, and immediately removing an item from a preexisting watch list. For example, when using the network environment 100, one of the users 136 may make an input into one of the user devices 118 that causes that one of the user devices 118 to communicate (to the WLM 220; through the network 112 and the NIM 260) a request to make a non-time-based watch list change. And, accordingly, the WLM 220 may understand the request to indicate that the WLM 220 is to make a non-time-based watch list change. If the method 300 determines that the method 300 will make one or more non-time-based watch list changes, then the method 300 goes to step 324 (described below); otherwise, the method 300 goes to step 356 (described below).

At step 324, the method 300 receives specifications of one or more items to include on a watch list. Such specifications may include, among other things, identifications of the items and identifications of information desired for monitoring the items. For example, when using the network environment 100, one of the users 136 may make an input into one of the user devices 118 that causes that one of the user devices 118 to communicate (to the WLM 220; through the network 112 and the NIM 260) data corresponding to a stock symbol or other identification of a publicly traded security, data corresponding to a name or other identification of a person, or data corresponding to an identification of anything else which that one of the users 136 would like to have on a watch list maintained by the WLM 220. Further, the one of the users 136 may also make an input into one of the user devices 118 that causes that one of the user devices 118 to communicate (to the WLM 220; through the network 112 and the NIM 260) a description of information regarding the item (e.g., the price of a stock, the whereabouts of a person, or any other desired available information about the specified item) to obtain (from the one or more information services server devices 128; through the network 112 and the NIM 260) for monitoring the item. And, accordingly, the WLM 220 may receive (through the network 112 and the NIM 260) the specifications of the item(s) from the one of the user devices 118. After step 324, the method 300 goes to step 340 (described below).

At step 340, the method 300 generates a new watch list (if the method 300 has determined, at step 308, that a new watch is desired) or updates (i.e., revises, changes, or modifies) a preexisting watch list (if the method 300 has determined, at step 308, that an update is desired). For example, when using the network environment 100, the WLM 220 may generate a new watch list (if the method 300 has determined, at step 308, that a new watch is desired) or update a preexisting watch list (if the method 300 has determined, at step 308, that an update is desired). It should be appreciated that the WLM 220 may maintain the new or updated watch list in any suitable memory. After step 340, the method 300 goes to step 356 (described below).

At step 356, the method 300 monitors the one or more items listed on the current watch list, where the current watch list comprises the new or updated watch list (generated at step 340) as modified by any time-based change(s) (time-based changes are described below in connection with the method 400, which is illustrated in FIG. 4). For example, when using the network environment 100, the WLM 220 may communicate (through the NIM 260 and the network 112) one or more requests to the one or more information services server devices 128 for the specified information (specified in the specifications received at step 324 (discussed above) and/or specified in the specifications received at step 408 of the method 400 (the method 400 is not illustrated in FIG. 3, but see FIG. 4); and received at step 356) regarding the one or more items on the current watch list maintained by the WLM 220. And, in response, the one or more information services server devices 128 may communicate (through the network 112 and the NIM 260) the requested information to the WLM 220. After step 356, the method 300 goes to step 372 (described below).

At step 372, the method 300 determines whether to generate a watch list report comprising the current watch list (described above) and comprising the corresponding specified information (specified in the specifications received at step 324 (discussed above) and/or specified in the specifications received at step 408 of the method 400 (the method 400 is not illustrated in FIG. 3, but see FIG. 4); and received at step 356) regarding the one or more items on the current watch list. For example, when using the network environment 100, one of the users 136 may make an input into one of the user devices 118 that causes that one of the user devices 118 to communicate (to the WLM 220; through the network 112 and the NIM 260) a request for a watch list report. And, in response, the WLM 220 may generate the watch list report. If the method 300 generates the watch list report, then the method 300 goes to step 388 (described below); otherwise, the method 300 goes to step 308 (described above).

At step 388, the method 300 communicates the watch list report (generated at step 372) to a user device. For example, when using the network environment 100, the WLM 220 may communicate (through the NIM 260 and the network 112) the watch list report to the one of the user devices 118 that has communicated (at step 372) the request for the watch list report. After step 388, the method 300 goes to step 308 (described above).

FIG. 4 is a flowchart illustrating the time-based watch list modification method 400 in accordance with aspects of the present disclosure. In some instances, one or more steps of the method 400 may be performed by one or more of the systems and/or components described herein. For clarity of exposition, the following description may refer to one or more of such systems and/or components. Nevertheless, it should be appreciated that the method 400 and/or any one or more of its particular steps may be performed by any suitable system(s) and/or component(s). It should also be appreciated that the method 400 may be performed concurrently or substantially concurrently with any other method(s) and/or process(es) described herein.

At step 404, the method 400 determines whether the method 400 will make one or more time-based changes to a watch list (as opposed to one or more non-time-based changes, described above in connection with the method 300, which is illustrated in FIG. 3), where a time-based change to a watch list will comprise adding an item to the watch list such that the method 400 will automatically remove the item from the watch list after a specific amount of time. For example, when using the network environment 100, one of the users 136 may make an input into one of the user devices 118 that causes that one of the user devices 118 to communicate (to the WLMM 240; through the network 112 and the NIM 260) a request to make a time-based watch list change. And, accordingly, the WLMM 240 may understand the request to indicate that the WLMM 240 is to make a time-based watch list change. If the method 400 determines that the method 400 will make one or more time-based watch list changes, then the method 400 goes to step 408 (described below); otherwise, the method 400 goes to step 456 (described below).

At step 408, the method 400 receives a specification of an item to be added to a watch list. The specification may include, among other things, an identification of the item and an identification of information desired for monitoring the item. For example, when using the network environment 100, one of the users 136 may make an input into one of the user devices 118 that causes that one of the user devices 118 to communicate (to the WLMM 240; through the network 112 and the NIM 260) data corresponding to a stock symbol or other identification of a publicly traded security, data corresponding to a name or other identification of a person, or data corresponding to an identification of anything else which that one of the users 136 would like to have added to a current watch list maintained by the WLM 220. Further, the one of the users 136 may also make an input into one of the user devices 118 that causes that one of the user devices 118 to communicate (to the WLMM 240; through the network 112 and the NIM 260) a description of information regarding the item (e.g., the price of a stock, the whereabouts of a person, or any other desired available information about the specified item) to obtain (from the one or more information services server devices 128; through the network 112 and the NIM 260) for monitoring the item. And, accordingly, the WLMM 240 may receive (through the network 112 and the NIM 260) the specification of the item from the one of the user devices 118. Further, the WLMM 240 may communicate the specification to the WLM 220. After step 408, the method 400 goes to step 424 (described below).

At step 424, the method 400 receives a specification of an amount of time beyond which to automatically remove the specified item (specified at step 408) from the watch list. For example, when using the network environment 100, one of the users 136 may make an input into one of the user devices 118 that causes that one of the user devices 118 to communicate (to the WLMM 240; through the network 112 and the NIM 260) an amount of time beyond which that one of the users 136 would like to have the specified item automatically removed from the current watch list (maintained by the WLM 220). And, accordingly, the WLMM 240 may receive (through the network 112 and the NIM 260) the specification of the time. After step 424, the method 400 goes to step 440 (described below).

At step 440, the method 400 adds the specified item (specified at step 408) to the watch list and records a time corresponding to when the specified item is added to the watch list. For example, when using the network environment 100, the WLMM 240 communicates an identification of the specified item (and a command to add the specified item to the watch list) to the WLM 220. And, accordingly, the WLM 220 adds the specified item to the watch list. Further, the WLMM 240 records the time that the WLMM 240 communicated the command to add the specified item to the watch list. After step 440, the method 400 goes to step 456 (described below).

At step 456, the method 400 determines an amount of time corresponding to how long (since the specified item was added to the watch list, at step 440) the specified item has been on the watch list. For example, when using the network environment 100, the WLMM 240 maintains an internal clock or timer (not shown) and compares a current timestamp or other current temporal data (generated by the clock or timer) to the time (recorded at step 440) that the WLMM 240 communicated the command to add the item to the watch list. It should be appreciated that the difference between the current temporal data and the time that the WLMM 240 communicated the command to add the item to the watch list should suitably correspond to how long the item has been on the watch list. After step 456, the method 400 goes to step 472 (described below).

At step 472, the method 400 determines whether the amount of time corresponding to how long the specified item has been on the watch list (determined at step 456) has exceeded the amount of time (specified at step 424) beyond which the specified item is to be removed from the watch list. For example, when using the network environment 100, the WLMM 240 determines whether the amount of time corresponding to how long the specified item has been on the watch list (determined at step 456) is greater than the amount of time (specified at step 424) beyond which the specified item is to be removed from the watch list. If the method 400 determines that the amount of time corresponding to how long the specified item has been on the watch list is greater than the amount of time beyond which the specified item is to be removed from the watch, then the method 400 goes to step 488 (described below); otherwise, the method 400 goes to step 456 (described above).

At step 488, the method 400 automatically removes the specified item (specified at step 408) from the watch list. For example, when using the network environment 100, the WLMM 240 communicates a command to the WLM 220 to remove the specified item (specified at step 408) from the current watch list maintained by the WLM 220. And, accordingly, the WLM 220 removes the specified item from the watch list. After step 488, the method 400 goes to step 404 (described above).

FIG. 5 is a block diagram illustrating a hardware architecture of a data processing system 500 in accordance with aspects of the present disclosure. In some embodiments, one or more of the systems and/or components described herein (e.g., the network 112, the one or more user devices 118, the one or more remote data-storage modules 124, the one or more watch list server devices 130) may be implemented using a corresponding one or more of the data processing system 500. Moreover, the data processing system 500 may be configured to store and execute one or more instructions of one or more of the methods and/or any other processes described herein.

The data processing system 500 employs a hub architecture including north bridge and memory controller hub (“NB/MCH”) 506 and south bridge and input/output (“I/O”) controller hub (“SB/ICH”) 510. Processor(s) 502, main memory 504, and graphics processor 508 are connected to NB/MCH 506. Graphics processor 508 may be connected to NB/MCH 506 through an accelerated graphics port (“AGP”). A computer bus, such as bus 532 or bus 534, may be implemented using any type of communication fabric or architecture that provides for a transfer of data between different components or devices attached to the fabric or architecture.

Network adapter 516 connects to SB/ICH 510. Audio adapter 530, keyboard and mouse adapter 522, modem 524, read-only memory (“ROM”) 526, hard disk drive (“HDD”) 512, compact disk read-only memory (“CD-ROM”) drive 514, universal serial bus (“USB”) ports and other communication ports 518, and peripheral component interconnect/peripheral component interconnect express (“PCl/PCIe”) devices 520 connect to SB/ICH 510 through bus 532 and bus 534. PCl/PCIe devices 520 may include, for example, Ethernet adapters, add-in cards, and personal computing (“PC”) cards for notebook computers. PCI uses a card bus controller, while PCIe does not. ROM 526 may comprise, for example, a flash basic input/output system (“BIOS”). Modem 524 or network adapter 516 may be used to transmit and receive data over a network.

HDD 512 and CD-ROM drive 514 connect to SB/ICH 510 through bus 534. HDD 512 and CD-ROM drive 514 may use, for example, an integrated drive electronics (“IDE”) or serial advanced technology attachment (“SATA”) interface. In some embodiments, the HDD 512 may be replaced by other forms of data storage devices including, but not limited to, solid-state drives (“SSDs”). A super I/O (“SIO”) device 528 may be connected to SB/ICH 510. SIO device 528 may comprise a chip on the motherboard that is configured to assist in performing less demanding controller functions for the SB/ICH 510 such as controlling a printer port, controlling a fan, and/or controlling the small light emitting diodes (“LEDS”) of the data processing system 500.

The data processing system 500 may include a single processor 502 or may include a plurality of processors 502. Additionally, the processor(s) 502 may have multiple cores. In some embodiments, the data processing system 500 may employ a large number of the processor(s) 502 that include hundreds or thousands of processor cores. In some embodiments, the processor(s) 502 may be configured to perform a set of coordinated computations in parallel.

An operating system is executed on the data processing system 500 using the processor(s) 502. The operating system coordinates and provides control of various components within the data processing system 500. Various applications and services may run in conjunction with the operating system. Instructions for the operating system, applications, and other data are located on storage devices, such as one or more of the HDD 512, and may be loaded into main memory 504 for execution by the processor(s) 502. In some embodiments, additional instructions or data may be stored on one or more external devices. The processes described herein for the illustrative embodiments may be performed by the processor(s) 502 using computer usable program code, which may be located in a memory such as, for example, main memory 504, ROM 526, or in one or more peripheral devices.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In accordance with aspects of the present disclosure, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing a watch list to a user device, the method comprising:
receiving a specification of an item to be added to the watch list;
receiving a specification of an amount of time beyond which to automatically remove the item from the watch list;
adding the item to the watch list;
automatically removing the item from the watch list based on a determination that an amount of time corresponding to how long the item has been on the watch list exceeds the amount of time beyond which to remove the item from the watch list; and
after automatically removing the item from the watch list, communicating the watch list, without the item, to the user device.

2. The method of claim 1, wherein receiving the specification of the item to be added to the watch list comprises receiving data corresponding to an identification of a publicly traded security.

3. The method of claim 2, wherein receiving data corresponding to the identification of the publicly traded security comprises receiving data corresponding to a stock symbol.

4. The method of claim 1, wherein receiving the specification of the item to be added to the watch list comprises receiving data corresponding to an identification of a person.

5. The method of claim 4, wherein receiving data corresponding to the identification of the person comprises receiving data corresponding to a name of the person.

6. The method of claim 1, wherein receiving the specification of the item to be added to the watch list comprises receiving a communication made through a cellular network.

7. The method of claim 1, wherein receiving the specification of the item to be added to the watch list comprises receiving a communication made through the Internet.

8. A system for providing a watch list to a user device, the system comprising:
a memory having instructions therein; and
at least one processor in communication with the memory, wherein the at least one processor is configured to execute the instructions to:
receive a specification of an item to be added to the watch list;
receive a specification of an amount of time beyond which to automatically remove the item from the watch list;
add the item to the watch list;
automatically remove the item from the watch list based on a determination that an amount of time corresponding to how long the item has been on the watch list exceeds the amount of time beyond which to remove the item from the watch list; and
after the item has been automatically removed from the watch list, communicate the watch list, without the item, to the user device.

9. The system of claim 8, wherein the at least one processor is also configured to execute the instructions to receive, as at least a portion of the specification of the item to be added to the watch list, data corresponding to an identification of a publicly traded security.

10. The system of claim 9, wherein the at least one processor is also configured to execute the instructions to receive, as at least a portion of the data corresponding to the identification of the publicly traded security, data corresponding to a stock symbol.

11. The system of claim 8, wherein the at least one processor is also configured to execute the instructions to receive, as at least a portion of the specification of the item to be added to the watch list, data corresponding to an identification of a person.

12. The system of claim 11, wherein the at least one processor is also configured to execute the instructions to receive, as at least a portion of the data corresponding to the identification of the person, data corresponding to a name of the person.

13. The system of claim 8, wherein the at least one processor is also configured to execute the instructions to receive the specification of the item to be added to the watch list through a cellular network.

14. The system of claim 8, wherein the at least one processor is also configured to execute the instructions to receive the specification of the item to be added to the watch list through the Internet.

15. A computer program product for providing a watch list to a user device, the computer program product comprising a computer readable storage medium having program instructions embodied therewith, the program instructions executable by at least one processor to cause the at least one processor to:
receive a specification of an item to be added to the watch list;
receive a specification of an amount of time beyond which to automatically remove the item from the watch list;
add the item to the watch list;
automatically remove the item from the watch list based on a determination that an amount of time corresponding to how long the item has been on the watch list exceeds the amount of time beyond which to remove the item from the watch list; and
after the item has been automatically removed from the watch list, communicate the watch list, without the item, to the user device.

16. The computer program product of claim 15, wherein the program instructions are also executable by the at least one processor to cause the at least one processor to receive, as at least a portion of the specification of the item to be added to the watch list, data corresponding to an identification of a publicly traded security.

17. The computer program product of claim 16, wherein the program instructions are also executable by the at least one processor to cause the at least one processor to receive, as at least a portion of the data corresponding to the identification of the publicly traded security, data corresponding to a stock symbol.

18. The computer program product of claim 15, wherein the program instructions are also executable by the at least one processor to cause the at least one processor to receive, as at least a portion of the specification of the item to be added to the watch list, data corresponding to an identification of a person.

19. The computer program product of claim 18, wherein the program instructions are also executable by the at least one processor to cause the at least one processor to receive, as at least a portion of the data corresponding to the identification of the person, data corresponding to a name of the person.

20. The computer program product of claim 15, wherein the program instructions are also executable by the at least one processor to cause the at least one processor to receive the specification of the item to be added to the watch list through at least one network selected from the group consisting of a cellular network and the Internet.
